(19) United States
(12) Patent Application Publication
(10) Pub. No.: US 2025/0111369 A1
(43) Pub. Date: Apr. 3, 2025

(54) SYSTEMS AND METHODS FOR ACCOUNT MAPPING AND PERSONAL ACCOUNT NUMBER LINKING

(71) Applicant: Mastercard International Incorporated, Purchase, NY (US)

(72) Inventors: Shawn Mehrhoff, Saint Ann, MO (US); Alexander Liberson, Brooklyn, NY (US); Joseph Christopher Vance, Wentzville, MO (US); Ian Goldberg, Township of Washington, NJ (US); Nagendar Kishen Surapaneni, Chesterfield, MO (US); William Parkinson, Monroe, CT (US)

(73) Assignee: Mastercard International Incorporated, Purchase, NY (US)

(21) Appl. No.: 18/810,256

(22) Filed: Aug. 20, 2024

Related U.S. Application Data
(60) Provisional application No. 63/586,238, filed on Sep. 28, 2023.

(51) Int. Cl. G06Q 20/40; G06Q 20/10

(52) U.S. Cl. CPC G06Q 20/4015; G06Q 20/108

(57) ABSTRACT

A computer-implemented method for authentic payee verification for online payment transactions includes: receiving a personal account identifier; initiating a deposit routed according to the personal account identifier; and enabling verifier access to deposit account data of a putative payee, with the deposit account data including one or more data types that are comparable to authentic payee data held by a payor for performing the verification.

### RELATED APPLICATIONS

The current patent application claims the benefit under 35 U.S.C. § 119 (e) of the priority date of identically-titled U.S. Provisional Application Ser. No. 63/586,238, filed Sep. 28, 2023, the entire contents of which is hereby incorporated by reference, in its entirety, into the current patent application.

### FIELD OF THE DISCLOSURE

The field of the disclosure relates generally to systems and methods for obtaining payee verification for payments transactions and, more particularly, to systems and methods for obtaining account data and/or name verification of a payment transaction utilizing micro deposits.

### BACKGROUND OF THE DISCLOSURE

Online financial transactions often include payments or distributions from merchants or e-commerce platforms to consumers, online sellers, cardholders or others. However, such account registration, cash-out and/or disbursement events provide opportunities for fraud. For example, these payment events may be completed based on fraudulent account numbers and/or identifiers, e.g., where a payor-such as an e-commerce platform or merchant—is given a fraudulent account number for use in completing the cash-out or disbursement. Existing technology lacks sufficient means for thwarting such attempts at fraud.

### SUMMARY OF THE DISCLOSURE

This summary is not intended to identify essential features of the present invention and is not intended to be used to limit the scope of the claims. These and other aspects of the present invention are described below in greater detail.

In one aspect, a payee verification method is provided. The authentic payee verification method for online payment transactions includes: receiving a personal account identifier; initiating a deposit routed according to the personal account identifier; and enabling verifier access to deposit account data of a putative payee, with the deposit account data including one or more data types that are comparable to authentic payee data held by a payor for performing the verification.

In another aspect, a non-transitory computer-readable storage media is provided having computer-executable instructed stored thereon for payee verification for online payment transactions. When executed by at least one processor the computer-executable instructions cause the at least one processor to: receive a personal account identifier; initiate a deposit routed according to the personal account identifier; and enable verifier access to deposit account data of a putative payee, with the deposit account data including one or more data types that are comparable to authentic payee data held by a payor for performing the verification.

### BRIEF DESCRIPTION OF THE DRAWINGS

Embodiments of the present invention are described in detail below with reference to the attached drawing figures, wherein:

FIG. 1 is a block diagram of an exemplary environment and system for performing payee verification in accordance with embodiments of the present invention;

FIG. 2 is a simplified block diagram of an example computing device of a putative payee, such as a cardholder, for use in the environment and system shown in FIG. 1;

FIG. 3 is an example configuration of a server system for use by any one or more of the parties comprising the payment card network system shown in FIG. 1;

FIG. 4 is a flowchart illustrating at least a portion of the steps of a method for payee verification in accordance with embodiments of the present invention;

FIG. 5 is a schematic diagram of an embodiment of the system shown in FIG. 1, showing data flow among the parties for payee verification; and

FIG. 6 is a schematic diagram of another embodiment of the system shown in FIG. 1, showing data flow among the parties for payee verification.

The figures are not intended to limit the present invention to the specific embodiments they depict. The drawings are not necessarily to scale. Like numbers in the Figures indicate the same or functionally similar components.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. It is contemplated that the invention has general application to identifying attempted payee fraud. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, operation, etc. described in one embodiment may also be included in other embodiments but is not necessarily included. Thus, particular implementations of the present invention can include a variety of combinations and/or integrations of the embodiments described herein.

Online financial transactions often include payments or distributions from merchants or e-commerce platforms to cardholders, including consumers, online sellers and others. However, such account registration, cash-out and/or disbursement events provide opportunities for fraud. These payment events may be completed based on fraudulent account numbers and/or identifiers, for example where a payor-such as an online marketplace or merchant—is given a fraudulent account number for use in routing the payment to complete the cash-out or disbursement. Embodiments of the present invention provide an advanced fraud prevention mechanism for such cases.

### Exemplary System

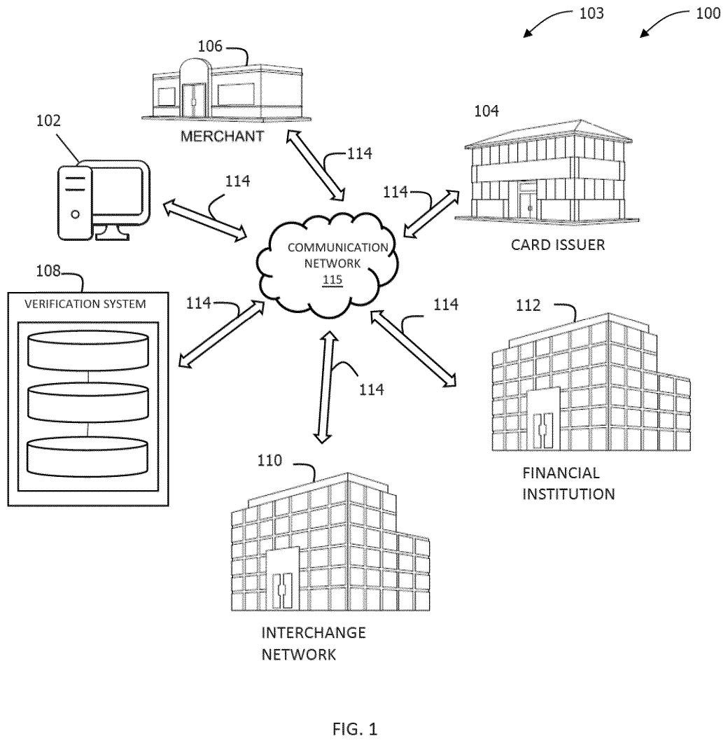

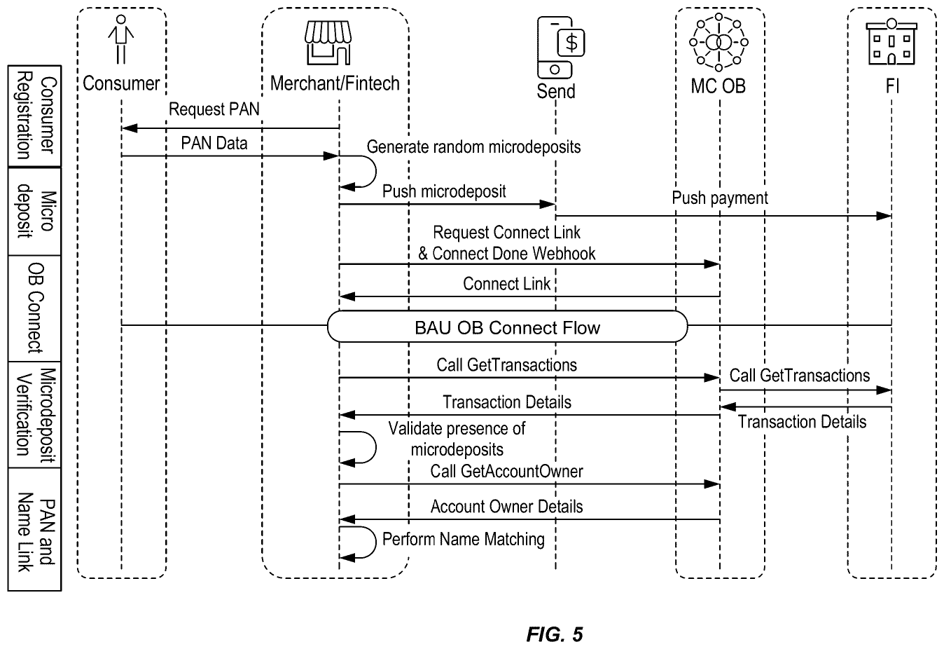

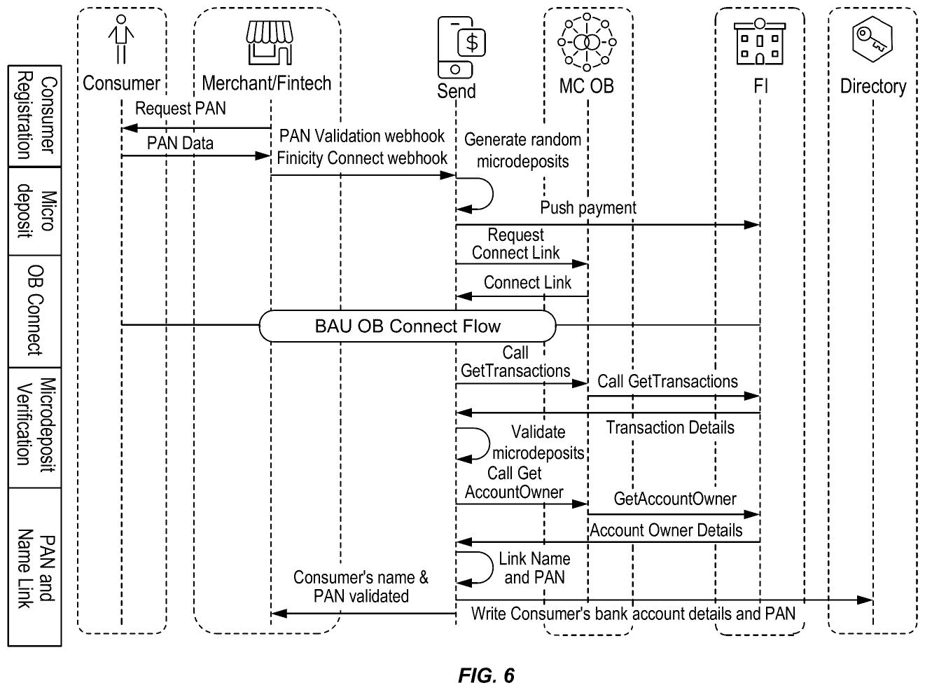

FIG. 1 depicts an exemplary environment 100 for payee verification according to embodiments of the present invention. The environment 100 may include a computing device 102 (see, e.g., “Consumer” component in FIGS. 5-6) and a payment card network system 103. The payment card network system 103 includes an issuer 104, a merchant 106, a verification system 108, an interchange network 110 (see, e.g., “Send” and “MC OB” components in FIGS. 5-6), and one or more financial institutions 112 (see, e.g., FI in FIGS. 5-6). The environment 100 also includes communication links 114 comprising and/or linking to a communication network 115.

In the exemplary embodiment, the payment card network system 103 facilitates providing interchange network services offered by interchange network 110. In addition, the payment card network system 103 enables payment card transactions in which merchants 106, issuers 104, and/or financial institutions 112 do not need to have a one-to-one relationship. Although parts of the payment card network system 103 are presented in one arrangement, other embodiments may include the same or different parts arranged otherwise, depending, for example, on authorization processes for purchase transactions, communication between computing devices, etc.

As used herein, the phrase “payment card network” or “interchange network” includes a system or network used for the transfer of funds between two or more parties using cash-substitutes. Transactions performed via a payment card network may include, for example, goods and/or service purchases, credit purchases, debit transactions, fund transfers such as disbursements and/or peer-to peer (P2P) transactions, account withdrawals or cash-outs, account openings and/or registrations, and the like. Payment card networks may be configured to perform such transactions using cash-substitutes including, for example, and without limitation, payment cards, checks, financial accounts, and the like. The phrases “payment card network” and/or “interchange network” may include the payment card network as an entity, and the physical payment card network, such as the equipment, hardware, and software making up the network.

In one or more embodiments, the interchange network 110 may include or comprise one or more services and corresponding servers (see FIG. 3) implementing features offered under the registered mark MASTERCARD SEND® of Mastercard International Incorporated as of the initial filing date of the present disclosure, including without limitation features for initiating and completing P2P payments and transactions between payees and payors. For example, in one or more embodiments, the interchange network 110 is configured to make one or more deposits (e.g., micro-deposits) into accounts associated with a personal account number (e.g., for a debit card) provided by a putative payee, and/or to complete cash-outs, withdrawals or distributions to a verified payee initiated by the merchant 106, as discussed in more detail below. It should be appreciated, however, that all or some such functions may be performed by other aspects of the payment card network 103 within the scope of the present invention, also as discussed in more detail below.

Further, in one or more embodiments, the interchange network 110 may include or comprise one or more services and corresponding servers (see FIG. 3) implementing features offered under the registered mark FINICITY® of Finicity Corporation as of the initial filing date of the present disclosure, including without limitation features for and comprising an open banking platform configured to manage cardholder payments, gain insight into spending trends and recommendations, manage finances and otherwise direct customary open banking functions. For example, in one or more embodiments, the interchange network 110 is configured to enable verifier access to banking records and account data of a putative payee, to retrieve and/or enable access to the account data, and/or perform other functions, as discussed in more detail below. It should be appreciated, however, that all or some such functions may be performed by other aspects of the payment card network 103 within the scope of the present invention, also as discussed in more detail below.

In the example embodiment, the payment card network system 103 generally includes the merchant 106, the issuer 104, the interchange network 110, and the financial institution(s) 112, coupled together in communication via links 114 and/or network 115. The links 114 and network 115 each includes, for example and without limitation, one or more of a local area network (LAN), a wide area network (WAN) (e.g., the Internet, etc.), a mobile network, a virtual network, and/or any other suitable public and/or private network capable of facilitating communication among the merchants 106, the issuers 104, the interchange network 110, and/or the financial institution(s) 112. In some embodiments, the links 114 and network 115 each may include more than one type of network, such as a private payment transaction network provided by the interchange network 110 to the issuers 104 and the financial institution(s) 112 and, separately, the public Internet, which may facilitate communication between the merchants 106, the interchange network 110, the issuers 104, and consumers, etc.

The links 114 and network 115 each may include the Internet, cellular communication networks, local area networks, metro area networks, wide area networks, cloud networks, plain old telephone service (POTS) networks, and the like, or combinations thereof. The links 114 and network 115 each may be wired, wireless, or combinations thereof and may include components such as modems, gateways, switches, routers, hubs, access points, repeaters, towers, and the like. The communication links 114 and network 115 each may include wires, such as electrical cables or fiber optic cables, or may be wireless, such as by operating via RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

Embodiments described herein may relate to a transaction card system, such as a credit card payment system using the MASTERCARD® interchange network. (MASTERCARD is a registered trademark of Mastercard International Incorporated.) The Mastercard interchange network is a set of proprietary communications standards promulgated by Mastercard International Incorporated for the exchange of financial transaction data and the settlement of funds between financial institutions that are members of Mastercard International Incorporated. As used herein, financial transaction data includes a unique account number (e.g., a personal account number or PAN) associated with an account holder or consumer using a payment card issued by an issuer and provided for receipt of withdrawals, cash-outs and/or disbursements from the merchant 106, which may be transmitted between any parties of the multi-party payment card network system 103.

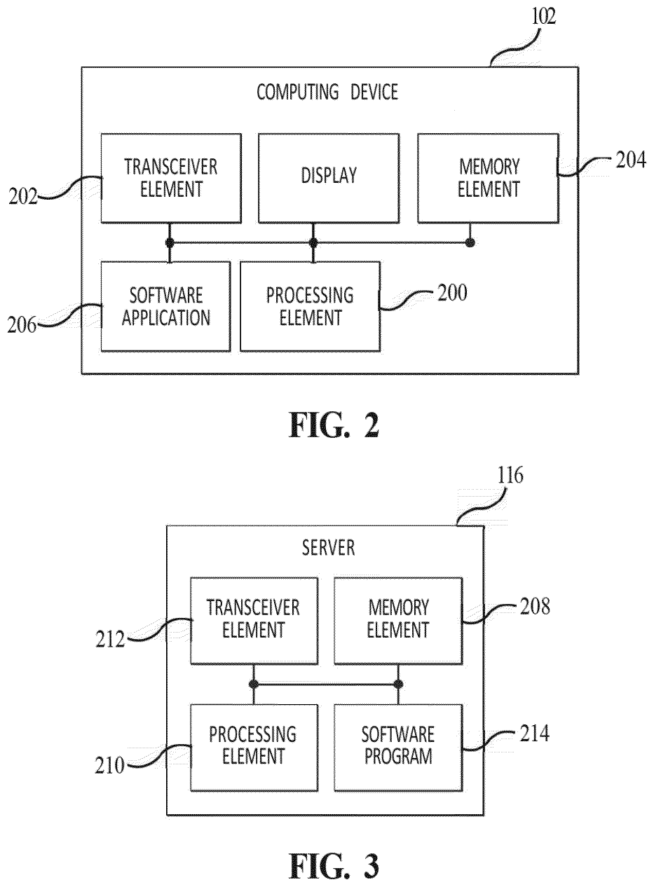

Turning briefly to FIG. 2, generally the computing device 102 may comprise tablet computers, laptop computers, desktop computers, workstation computers, smart phones, smart watches, and the like. Each computing device 102 may include a processing element 200 and a memory element 204. Each computing device 102 may also include circuitry capable of wired and/or wireless communication with the issuer 104, merchant 106, verification system 108, databases 110, and/or financial institution 112, including, for example, transceiver element 202. Further, the computing device 102 may include software 206 configured with instructions for performing and/or enabling performance of at least some of the steps set forth herein. In an embodiment, the software comprises programs stored on computer-readable media of memory element 204.

A location of the computing device 102 can be obtained through conventional methods, such as a location service (e.g., global positioning system (GPS) service) in the computing device 102, “ping” data that includes geotemporal data, from cell location register information held by a telecommunications provider to which the computing device 102 is connected, from an internet protocol (IP) address, and the like. For example, in one or more suitable embodiments, a GPS chip can be part of or separate from the processing element 200 to enable the location of the computing device 102 to be determined.

The computing device 102 also includes at least one media output component such as a display for presenting information to the user or cardholder. The media output component is any component capable of conveying information to the user. In some embodiments, the media output component includes an output adapter such as a video adapter and/or an audio adapter. An output adapter is operatively coupled to the processing element 200 and operatively connectable to an output device such as the display device, a liquid crystal display (LCD), organic light emitting diode (OLED) display, or “electronic ink” display, or an audio output device, a speaker, or headphones.

In some embodiments, the computing device 102 includes an input device for receiving input from the user. The input device may include, for example, aspects of the display such as a touch sensitive panel and/or a touch screen, and/or a touch pad, a stylus, a gyroscope, an accelerometer, a position detector, a keyboard, a pointing device, a mouse, or an audio input device. A single component such as a touch screen (display) may function as both an output device of the media output component and the input device.

Stored in the memory element 204 are, for example, computer readable instructions for providing a user interface to the user via the media output component and, optionally, receiving and processing input from the input device. A user interface may include, among other possibilities, a web browser and a client application. Web browsers enable users, such as the user, to display and interact with media and other information typically embedded on a web page or a website. Software application 206 allows the user to interact with a server application from one or more server systems of the card payment network.

In one or more embodiments, the merchant 106 may provide a withdrawal, cash-out and/or disbursement in connection with a refund to a cardholder or consumer using computing device 102. Also or alternatively, the merchant 106 may comprise an e-commerce platform administrator (such as, for example, the marketplace offered by Amazon Technologies, Inc. under the registered mark AMAZON®) or the like providing such payments to cardholders that are individual online sellers or the like. One of ordinary skill will appreciate that a variety of P2P, withdrawal, cash-out, disbursement and/or analogous payments are within the scope of the present invention.

The cardholder or consumer may, for example, use computing device 102 to register for or otherwise provide information such as a PAN in connection with such a putative withdrawal, cash-out and/or disbursement and thus be characterized as a “putative payee.”

In the exemplary embodiment, the computing device 102 may additionally be configured to facilitate cardholder setup of an account with the merchant 106 or a component of the interchange network 110. During the account setup process, the cardholder may transmit, via the computing device 102, account registration information including, for example, and without limitation, payment account data (e.g., the PAN, a virtual payment number, limited use number, etc.) and computing device 102 identification data (e.g., an Electronic Serial Number (ESN), Mobile Equipment Identifier (MEID), International Mobile Equipment Identity (IMEI) number, and the like).

For instance, the merchant 106 may receive account registration information from the computing device 102 identifying the computing device 102 and a payment account or PAN associated with the cardholder. The cardholder may, for example, set up the account with the merchant 106 by providing the account registration information and generating a login identifier (i.e., a UserID) and a password used when logging into an application for communicating with the merchant 106. The cardholder may transmit various information or data to the merchant 106, which may be stored on, partially stored on, or accessed via a web-browser of, the computing device 102. The cardholder and/or merchant 106 may generate a new account profile or update an existing account profile for the account associated with the account registration information received from the computing device 102 at least in part by linking the account to an existing eligible or authenticated (i.e., entitled) payee.

Turning briefly to FIG. 3, each of the merchant 106, the issuer 104, the interchange network 110, the financial institution(s) 112 and/or the verification system 108 comprises or includes one or more servers 116. In one or more embodiments, the verification system 108 is implemented partly or entirely by one or more independent server(s) 116 and/or by one or more server(s) 116 comprising and/or operated by one or more of the merchant 106, the issuer 104, the interchange network 110, and the financial institution(s) 112.

Each of the servers 116 generally manages queries to, and responsive assets (e.g., resources including data, files and the like) received from, data sources, and performs related functions. The servers 116 may comprise domain controllers, application servers, database servers, database web servers, file servers, mail servers, catalog servers or the like, or combinations thereof. In an embodiment, one or more data sources may be maintained by one or more of the servers 116, for example via a database management system. Generally, each server 116 may include a memory element 208, a processing element 210, a communication or transceiver element 212, and a software program 214.

Each of the servers 116 may also embody, implement and/or manage data discussed herein via one or more application programming interfaces (APIs). Each API may include and/or provide access to one or more pages or sets of data and/or other content accessed through the World Wide Web (e.g., through the communication network 115) and/or through the links 114. Each API may be hosted by or stored on a web server and/or database server, for example. The APIs may include top-level domains such as “.com”, “.org”, “.gov”, and so forth. The APIs may be accessed using software such as a web browser, through execution of one or more script(s) for obtaining data, and/or by other means for interacting with APIs without departing from the spirit of the present invention. Each API may be hosted and/or managed by a server constructed and operated, for example, in the manner described in connection with servers 116 herein.

Each transceiver element 202, 212 generally allows communication with computing device 102, the issuer 104, merchant 106, verification system 108, and financial institution(s) 112. The transceiver element 202, 212 may include signal or data transmitting and receiving circuits, such as antennas, amplifiers, filters, mixers, oscillators, digital signal processors (DSPs), and the like. The transceiver element 202, 212 may establish communication via the communication links 114 and/or network 115 wirelessly by utilizing radio frequency (RF) signals and/or data that comply with communication standards such as cellular 2G, 3G, 4G or 5G, Institute of Electrical and Electronics Engineers (IEEE) 802.11 standard such as WiFi, IEEE 802.16 standard such as WiMAX, Bluetooth™, or combinations thereof. In addition, the transceiver element 202, 212 may utilize communication standards via the communication links 114 and/or network 115 such as ANT, ANT+, Bluetooth™ low energy (BLE), the industrial, scientific, and medical (ISM) band at 2.4 gigahertz (GHz), or the like. Alternatively, or in addition, the transceiver element 202, 212 may establish communication through connectors or couplers that receive metal conductor wires or cables, like Cat 6 or coax cable, which are compatible with networking technologies such as ethernet. In certain embodiments, the transceiver element 202, 212 may also couple with optical fiber cables. Each transceiver element 202, 212 may respectively be in communication with the corresponding processing element 200, 210 and/or memory element 204, 208.

Each memory element 204, 208 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, each memory element 204, 208 may be embedded in, or packaged in the same package as, the corresponding processing element 200, 210. The memory element 204, 208 may include, or may constitute, a “computer-readable medium.” The memory element 204, 208 may store the instructions, code, code segments, software, firmware, programs, applications, apps, services, daemons, or the like that are executed by the corresponding processing element 200, 210. In an embodiment, each memory element 204, 208 respectively stores at least one of corresponding software applications 206, 214. The memory element 204, 208 may also store settings, data, documents, sound files, photographs, movies, images, databases, and the like.

Each processing element 200, 210 may include electronic hardware components such as processors. The processing element 200, 210 may include digital processing unit(s). The processing element 200, 210 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 200, 210 may generally execute, process, or run instructions, code, code segments, software, firmware, programs, applications, apps, processes, services, daemons, or the like. For instance, each processing element 200, 210 may execute corresponding software applications/programs 206, 214 stored on the respective memory element 204, 208 in connection with performing all or some of the steps described herein. The processing element 200, 210 may also include hardware components such as finite-state machines, sequential and combinational logic, and other electronic circuits that can perform the functions necessary for the operation of the current invention. The processing element 200, 210 may be in communication with the other electronic components through serial or parallel links that include universal busses, address busses, data busses, control lines, and the like.

Through hardware, software, firmware, or various combinations thereof, the processing elements 200, 210 may—alone or in combination with other processing elements—be configured to perform the operations of embodiments of the present invention. Specific embodiments of the technology will now be described in connection with the attached drawing figures.

### Exemplary Computer-Implemented Payee Verification Methods

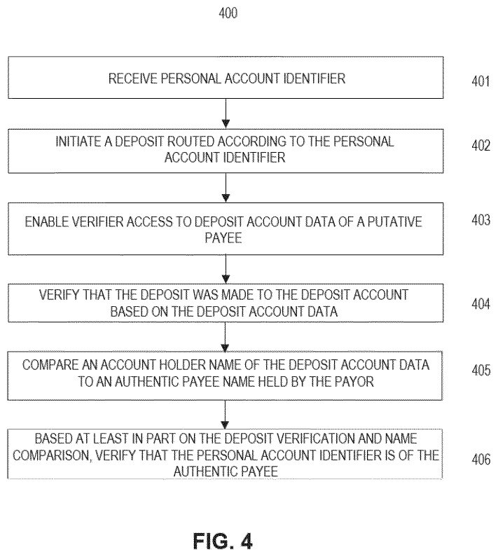

FIG. 4 depicts a block flow diagram associated with exemplary computer-implemented method(s) for payee verification and/or methods for improving payee verification. Some steps of the method of FIG. 4 may be performed concurrently as opposed to sequentially and may in some cases be performed in a different order. In addition, some steps may be optional. Moreover, the steps of the method of FIG. 4 may be performed together with any other of the steps discussed herein within the scope of the present invention.

The computer-implemented method(s) are described below, for ease of reference, as being executed by exemplary devices and components introduced with the embodiments illustrated in FIGS. 1-3. For example, the steps of the computer-implemented method(s) may be performed by the processor or transceiver of the computing device and one or more servers of the payment card network, at least in part through the utilization of processors, transceivers, hardware, software, firmware, or combinations thereof. However, it should also be noted that one or more steps of the payee verification operations discussed herein may be performed by the verification system of FIG. 1, whether independently or as integrated with the system(s) of one or more components of the payment card network discussed above, within the scope of the present invention.

In one or more embodiments, the steps set out below for a single transaction are substantially repeated in connection with executing a plurality of transactions on the same or similar payment networks. A person having ordinary skill will also appreciate that responsibility for all or some of such actions may be distributed differently among such devices or other computing devices without departing from the spirit of the present invention.

One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 401, a personal account identifier may be received. In one or more embodiments, the personal account identifier is a PAN received from or via a computing device of or purportedly associated with an entity or party, such as a consumer or seller, entitled to payment from a merchant. For example, in one or more embodiments, the PAN is input by a user of the computing device during a registration, cash-out, withdrawal and/or disbursement procedure and/or is inserted into such data after initial population. Because the PAN is thus associated with a future or pending payment, and is intended for use in routing the payment, there is incentive for fraudulent population of the corresponding data field(s) and corresponding misrouting of the payment to fraudulent accounts.

In one or more embodiments, for example, the future or pending payment may comprise a refund (e.g., in the case of an individual consumer cardholder), an insurance payment, or a payment from an e-commerce platform to an online seller associated with sale of goods or services of the online seller via the platform. One of ordinary skill will appreciate that a variety of payees and merchants or other payors are within the scope of the present invention.

The PAN may be received directly by the merchant or payor and/or by one or more parties in a payment card network (e.g., by a party comprising or implementing an interchange network). For example, in one or more embodiments the user of the computing device provides the PAN to the merchant in response to a request from the merchant (see FIGS. 5-6). The merchant may further transmit the received PAN to a party comprising or implementing the interchange network. (See FIG. 6) Further, the PAN may be passed to a direct payment facilitating service, such as that offered under the registered mark MASTERCARD SEND®.

It should be appreciated that while the present disclosure primarily discusses a personal account identifier comprising a PAN, other representative information associated with payment accounts—such as tokens or the like—are also within the scope of personal account identifiers and embodiments of the present invention. For example, in embodiments where the identifier is a token, the token may be decoded to obtain an account number and PAN for use in routing payment(s) according to embodiments described herein.

Referring to step 402, a deposit may be initiated and/or routed according to the personal account identifier. The deposit may be triggered or initiated based on one or both of an online account opening and an account cash-out request. In one or more embodiments, the deposit is a “micro-deposit” initiated at least in part to link the PAN to an existing account (i.e., to a deposit account discussed in more detail below). The existing account may be one enrolled in an open banking service and/or known to a financial institution. For example, the existing account may be associated with trusted information and authentication data and/or with additional historical transaction information.

Moreover, the amount of the micro-deposit may be randomized to prevent predictability, provided that the amount may be subject to a maximum threshold.

The deposit routed according to the PAN may be initiated by the merchant (see FIG. 5), by the party comprising or implementing the interchange network (see FIG. 6), such as a payment processor, and/or by another party of the payment card network within the scope of the present invention. In embodiments in which the deposit is initiated by the party of the interchange network, the merchant may register and/or enroll in the payee verification service provided by that party prior to initiating the payee verification operations of embodiments of the present invention. (See FIG. 6)

The deposit may further be completed by the payment card network. For example, the interchange network may push the deposit to the financial institution according to the PAN for completion of the deposit.

Referring to step 403, verifier access to deposit account data of the putative payee may be enabled. In one or more embodiments, the user inputting the PAN via the computing device may be asked to log in (e.g., via the computing device) to an open banking service and/or financial institution online account portal using corresponding credentials to provide consent and access to deposit account records and/or data needed to verify the user's link to or identity as the entitled payee. For example, the deposit account records and/or data may include or comprise individual name(s) associated with the deposit account, transaction history (e.g., between the deposit account and the merchant payor) for the corresponding deposit account, address information for the individual(s) associated with the deposit account, and other information which may be cross-referenced against records held by the payor regarding the entitled payee. In one or more embodiments, the deposit account is a demand deposit account.

The verifier access may be provided to one or more of the merchant (see FIG. 5), an interchange network service (see FIG. 6), such as a payment processor, a financial institution and/or another party of the payment card network which, in each case, may comprise and/or perform aspects of the payee verification system.

Referring to step 404, it may be verified that the deposit routed according to the personal account identifier was made to the deposit account for which the verifier access was provided, based on the deposit account data. In one or more embodiments, verifying that the deposit routed according to the PAN arrived in the deposit account for which the verifier access was provided (and which is associated with trusted information, as discussed in more detail above) helps link the user of the computing device and/or putative payee to that deposit account. This substantiates and/or authenticates the link between the account data and the user.

The verification may include matching the date/time of deposit, the amount of the deposit, or other information regarding the deposit to the account data for the deposit account accessed via the verifier access.

The verification of the deposit may be performed by one or more of the merchant (see FIG. 5), an interchange network service (see FIG. 6), such as a payment processor, a financial institution and/or another party of the payment card network which, in each case, may comprise and/or perform aspects of the payee verification system. Preferably, the verification of the deposit is made by the entity to which verifier access was provided according to step 403.

Referring to step 405, an account holder name of the deposit account data may be compared to an authentic or entitled payee name held by the payor. In one or more embodiments, the payor may hold a limited amount of information regarding the authentic or entitled payee. The information may include the name of the entitled payee, but little else. Accordingly, step 405 may include matching the name of the entitled or authentic payee to one or more name(s) associated with the deposit account for which verifier access was provided. This, alone or together with verification that the deposit routed according to the PAN arrived at the deposit account, may bolster the conclusion that the user of the computing device and/or the PAN are authentic and associated with the entitled payee.

In one or more embodiments, the entitled payee name held by the payor may be related to a name associated with the deposit account according to rules requiring other than strict identity of character strings and/or that generate a name matching score. For example, a “fuzzy” matching rule for generating a name matching score that may authenticate or verify relationships between the compared names may account for common variations on names, misspellings, truncations, name changes and/or marriage, familiar relationships/relatives, or other common reasons why failure of complete or identical matching may nonetheless result in verification or authentication linking the deposit account and PAN to the entitled payee. It should also be noted that the “name” may also or alternatively be a government-issued identification or unique identifier, and/or that an additional data type may comprise such an identification or unique identifier for independent matching and verification in connection with computing the PAN verification discussed in more detail below.

In one or more embodiments, such rules may generate a scaled score or other non-binary indicator of confidence in linking the deposit account and PAN to the entitled payee. Further, the indicator of confidence, name matching score, and/or other output may be compared against one or more thresholds for PAN verification and/or to trigger further information gathering and verification steps (in each case, discussed in more detail below).

The verification of the name may be performed by one or more of the merchant (see FIG. 5), an interchange network service (see FIG. 6), such as a payment processor, a financial institution and/or another party of the payment card network which, in each case, may comprise and/or perform aspects of the payee verification system. Preferably, the verification of the name is made by the entity to which verifier access was provided according to step 403 and/or by the entity performing the deposit verification according to step 404.

Referring to step 406, based at least in part on the deposit verification and the name comparison and/or verification, it is verified that the identifier is associated with the authentic or entitled payee. In one or more embodiments, the verification is partly or entirely a formalized conclusion noting that the deposit and name verification steps were satisfactorily completed. However, the PAN verification may also or alternatively take the form of a scaled score or other non-binary output. Such output may reflect a level of confidence in linking the PAN to the entitled payee. Such output may be based on a confluence of factors, such as the degree of name matching and/or the degree to which other deposit account data matches or correlates with data held by or verifiable to the payor or an entity of the card payment network regarding the entitled payee.

Such other account data regarding the deposit account may also be of additional data types comparable to data about the entitled payee held by or accessible to the payor. Gathering data of the additional data types and corresponding comparisons and matching discussed below may be performed in each instance or may be performed contingently, for example based on the degree of PAN verification and/or threshold satisfaction achieved by the deposit and/or name matching steps discussed above. For example, historical transaction data of the account data and/or banking records may be compared to transactions the payor executed with, or which the payor is otherwise assured involved, the entitled payee. If matches are found—for example, using the same or similar criteria discussed above in connection with matching the deposit—in the historical transaction data, the PAN verification score or analogous output may be enhanced or increased and/or verification/authentication confirmed.

For another example, address information of the account data for entities and/or individuals associated with the deposit account may be compared against location data for the user computing device. In one or more embodiments, the merchant and/or interchange network may identify a location of the cardholder's computing device, for example, by requesting location data from the computing device. The location, or a plurality of locations tracked over a period of time, can be determined through a location service associated with the computing device, via GPS data received from the computing device, or other means. The merchant and/or interchange network may compare the identified location(s) of the cardholder's computing device (based on the GPS location data received from the cardholder's computing device, on IP address of the computing device, or the like) to the address(es) of the account data. The merchant and/or interchange network may determine whether the difference in the identified location(s) of the cardholder's computing device and one or more of the account data address(es) is below a predefined threshold distance and may use this determination in performing the PAN verification. Namely, if a close match is found, the PAN verification score or analogous output may be enhanced or increased.

The PAN verification may be performed by one or more of the merchant (see FIG. 5), an interchange network service (see FIG. 6), such as a payment processor, a financial institution and/or another party of the payment card network which, in each case, may comprise and/or perform aspects of the payee verification system. Preferably, the PAN verification is made by the entity to which verifier access was provided according to step 403, by the entity performing the deposit verification according to step 404, and/or by the entity performing the name verification according to step 405.

The PAN verification may be issued to the merchant and/or payor to support a decision regarding whether to make the withdrawal, cash-out and/or disbursement to the PAN provided by the user or cardholder. The PAN verification may also or alternatively be directly acted on by the interchange network or another party of the payment card network, for example by initiating the withdrawal, cash-out and/or disbursement based on the PAN verification. Also or alternatively, if the PAN verification fails (e.g., fails to satisfy a threshold or condition), the interchange network, merchant, verification system and/or another party of the payment card network may save a record of the PAN (e.g., in the directory illustrated in FIG. 6). The record may permit faster and more confident identification of attempted fraud wherever the PAN is encountered in connection with future transactions.

Any actions, functions, operations, and the like recited herein may be performed in the order shown in the figures and/or described above or may be performed in a different order. Furthermore, some operations may be performed concurrently as opposed to sequentially. Although the computer-implemented method is described above, for the purpose of illustration, as being executed by an example system and/or example physical elements, it will be understood that the performance of any one or more of such actions may be differently distributed without departing from the spirit of the present invention.

A computer-readable storage media or medium comprising a non-transitory medium may include an executable computer program stored thereon for instructing one or more processing elements to perform some or all the operations described herein, including some or all of the operations of the computer-implemented method. The computer program stored on the computer-readable medium may instruct the processor and/or other components of the system to perform additional, fewer, or alternative operations, including those discussed elsewhere herein.

All terms and phrases used herein are to be broadly interpreted unless otherwise stated. For example, the phrases “transaction card,” “payment card,” and the like may, unless otherwise stated, broadly refer to substantially any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transaction card can be used as a method of payment for performing a transaction.

The terms “processor,” “processing element,” and the like, as used herein, may, unless otherwise stated, broadly refer to any programmable system including systems using central processing units, microprocessors, microcontrollers, reduced instruction set circuits (RISC), application specific integrated circuits (ASIC), logic circuits, and any other circuit or processor capable of executing the functions described herein. The above examples are example only and are thus not intended to limit in any way the definition and/or meaning of the term “processor.” In particular, a “processor” may include one or more processors individually or collectively performing the described operations. In addition, the terms “software,” “computer program,” and the like, may, unless otherwise stated, broadly refer to any executable code stored in memory for execution on mobile devices, clusters, personal computers, workstations, clients, servers, and a processor. The term “memory” includes read-only memory (ROM), electronic programmable read-only memory (EPROM), random access memory (RAM), erasable electronic programmable read-only memory (EEPROM), and non-volatile RAM (NVRAM) memory. The above memory types are example only and are thus not limiting as to the types of memory usable for storage of a computer program.

The terms “computer,” “computing device,” “computer system,” and the like, as used herein, may, unless otherwise stated, broadly refer to substantially any suitable technology for processing information, including executing software, and may not be limited to integrated circuits referred to in the art as a computer, but may broadly refer to a microcontroller, a microcomputer, a programmable logic controller (PLC), an application specific integrated circuit, and other programmable circuits, and these terms are used interchangeably herein.

The terms “network,” “communications network,” “communication link” and the like, as used herein, may, unless otherwise stated, broadly refer to substantially any suitable technology for facilitating communications (e.g., GSM, CDMA, TDMA, WCDMA, LTE, EDGE, OFDM, GPRS, EV-DO, UWB, WiFi, IEEE 802 including Ethernet, WiMAX, and/or others), including supporting various local area networks (LANs), personal area networks (PAN), or short-range communications protocols.

The term “communication component,” “communication interface,” “transceiver” or “communication” element and the like, as used herein, may, unless otherwise stated, broadly refer to substantially any suitable technology for facilitating communications, and may include one or more transceivers (e.g., WWAN, WLAN, and/or WPAN transceivers) functioning in accordance with IEEE standards, 3GPP standards, or other standards, and configured to receive and transmit signals via a communications network.

The term “memory area,” “storage device,” and the like, as used herein, may, unless otherwise stated, broadly refer to substantially any suitable technology for storing information, and may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

What is claimed is:

1. A computer-implemented method for authentic payee verification for online payment transactions comprising, via one or more transceivers and/or processors:
receiving a personal account identifier;
initiating a deposit routed according to the personal account identifier; and
enabling verifier access to deposit account data of a putative payee, the deposit account data including one or more data types that are comparable to authentic payee data held by a payor for performing the verification.

2. The computer-implemented method of claim 1, further comprising, via the one or more processors and/or transceivers, confirming that the deposit was made to the deposit account based on the deposit account data and, based at least in part on the confirmation, performing the verification.

3. The computer-implemented method of claim 1, wherein the authentic payee data held by the payor includes an authentic payee name.

4. The computer-implemented method of claim 3, wherein the one or more data types includes putative payee name data, further comprising, via the one or more processors and/or transceivers, comparing putative payee name data to the authentic payee name to perform the verification of the authentic payee.

5. The computer-implemented method of claim 4, wherein the comparison includes generating a name matching score based at least in part on how closely the putative payee name data matches the authentic payee name.

6. The computer-implemented method of claim 5, wherein the personal account identifier is provided via a user device, further comprising, via the one or more processors and/or transceivers and based on comparing the name matching score to at least one matching threshold—
requesting, based on an initial computation of the verification, a device location of the user device,
comparing the device location to address information of the deposit account data,
completing the verification based at least in part on the comparison of the device location to address information.

7. The computer-implemented method of claim 1, wherein the one or more data types include historical transaction data.

8. The computer-implemented method of claim 1, wherein the one or more data types include a government-issued identification.

9. The computer-implemented method of claim 1, further comprising comparing the data regarding the deposit account to the authentic payee data to perform the verification of the authentic payee.

10. The computer-implemented method of claim 1, further comprising, via the one or more processors and/or transceivers, confirming that the deposit was made to the deposit account based on the banking records, wherein the merchant is the payor and the merchant performs the comparison and the confirmation of the deposit.

11. The computer-implemented method of claim 1, further comprising, via the one or more processors and/or transceivers, confirming that the deposit was made to the deposit account based on the banking records, wherein a payment processor performs the matching, the initiating of the deposit, the enabling of the verifier access and the confirmation of the deposit.

12. The computer-implemented method of claim 11, wherein the payment processor enables the verifier access via receipt of login credentials at an online or mobile interface for a corresponding account registered to an open banking service of the payment processor.

13. The computer-implemented method of claim 12, further comprising, via the one or more processors and/or transceivers, the payment processor obtaining a use consent for the verification and the banking records from the putative payee.

14. The computer-implemented method of claim 1, wherein the personal account identifier is a personal account number corresponding to a debit card.

15. The computer-implemented method of claim 1, wherein the initiating of the deposit is triggered by one or both of an online account opening and an account cash-out request.

16. The computer-implemented method of claim 1, wherein the banking records are associated with a demand deposit account of the putative payee.

17. The computer-implemented method of claim 1, further comprising, via the one or more processors and/or transceivers and based on a failure of the verification, storing a record of the personal account identifier.

18. Non-transitory computer-readable storage media having computer-executable instructed stored thereon for payee verification for online payment transactions, wherein when executed by at least one processor the computer-executable instructions cause the at least one processor to:
receive a personal account identifier;
initiate a deposit routed according to the personal account identifier; and
enable verifier access to deposit account data of a putative payee, with the deposit account data including one or more data types that are comparable to authentic payee data held by a payor for performing the verification.

19. The non-transitory computer-readable storage media of claim 18, wherein the computer-executable instructions further cause the at least one processor to confirm that the deposit was made to the deposit account based on the deposit account data and, based at least in part on the confirmation, perform the verification.

20. The non-transitory computer-readable storage media of claim 18, wherein the authentic payee data held by the payor includes an authentic payee name and the one or more data types includes putative payee name data, and wherein the computer-executable instructions further cause the at least one processor to compare putative payee name data to the authentic payee name to perform the verification of the authentic payee.
